(19) United States
(12) Patent Application Publication
(10) Pub. No.: US 2015/0058161 A1
(43) Pub. Date: Feb. 26, 2015

(54) AUTOMATICALLY FILLING ITEM INFORMATION FOR SELLING

(71) Applicants: Ron Gura, Tel Aviv (IL); Matanya Bar, Tel Aviv (IL); Erez Dickman, Tel Aviv (IL)

(72) Inventors: Ron Gura, Tel Aviv (IL); Matanya Bar, Tel Aviv (IL); Erez Dickman, Tel Aviv (IL)

(21) Appl. No.: 14/146,604

(22) Filed: Jan. 2, 2014

Related U.S. Application Data
(60) Provisional application No. 61/868,439, filed on Aug. 21, 2013.

(51) Int. Cl. G06Q 10/08

(52) U.S. Cl. CPC G06Q 10/087
USPC 705/26.8

(57) ABSTRACT

Systems and methods are disclosed which scan one or more inboxes of a user for product information that can be used to automatically provide item information when the user later wants to sell the item. The product information may include sufficient item information for selling the item or the product information may include information that can be used to search for and obtain the necessary item information. Systems and methods described herein may allow a user to quickly sell an item with a minimum of user input.

### CROSS REFERENCE TO RELATED APPLICATIONS

Pursuant to 35 U.S.C. §119(e), this application claims priority to the filing date of U.S. Provisional Patent Application No. 61/868,439, filed on Aug. 21, 2013, the disclosure of which is hereby incorporated by reference in its entirety.

### BACKGROUND

1. Technical Field

Embodiments disclosed herein are related to systems and methods for automatically filling item information for selling on an online marketplace with minimal input from the seller.

2. Related Art

The internet has connected sellers and buyers from across the globe using online marketplaces such as provided by eBay Inc. of San Jose, Calif. Instead of selling used items at garage sales and the like, sellers may be able to use online marketplaces such as eBay Inc. to sell these items and increase the number of potential buyers. In many instances, sellers must first provide a general description of their items before the item for sale may be viewable and searchable by would-be buyers using the online marketplace. The general description may include item information, such as the name of the item, brand, condition, when purchased, specifications, and other such information that may be useful to a would-be buyer for making a decision on buying the item. However, the seller may not know all of the details of the item information or may not be willing to properly fill in the item information, which may lead to an incomplete or poor item description that may hamper the seller's ability to sell the item, and a would-be buyer from finding the item in a search.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIGS. 3A-3C illustrate an example an example interface for selling items with minimal user input, consistent with some embodiments.

FIG. 4 is a flowchart illustrating a process for autofilling item information for selling, consistent with some embodiments.

FIG. 5 is a flowchart illustrating a process for scanning inboxes and autofilling item information for selling, consistent with some embodiments.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

There is a need for autofilling item information for selling based on information that the seller already has about the items.

Consistent with some embodiments, there is provided a system. The system includes a network interface component configured to receive messages over a network including product information for items purchased by a user, the product information including item information. The system also includes a memory configured to store the product information and item information, and one or more processors configured to automatically enter the item information into a selling description before the user lists one or more of the purchased items for sale.

Consistent with some embodiments, there is also provided a method including steps of retrieving product information associated with the item in response to receiving a selection of the item as an item to sell, the product information including information stored from scanning one or more inboxes, automatically entering the item information when the product information includes the item information, and searching for the item information based on the product information when the product information does not include the item information. The method may be embodied in computer-readable media.

Consistent with some embodiments, there is further provided a method including steps of scanning one or more inboxes associated with a user, storing product information from messages in the one or more inboxes, the product information including item information, determining if the item matches an stored product information when a request to sell the item is received, automatically entering the item information for the item when the item matches stored product information and the product information includes the item information, and searching for the item information based on the product information when the item matches stored product information and the product information does not include the item information. The method may be embodied in computer-readable media.

Embodiments consistent with this disclosure may scan a seller's inbox for messages related to the items to determine information about the item that can be used to autofill the item information for selling.

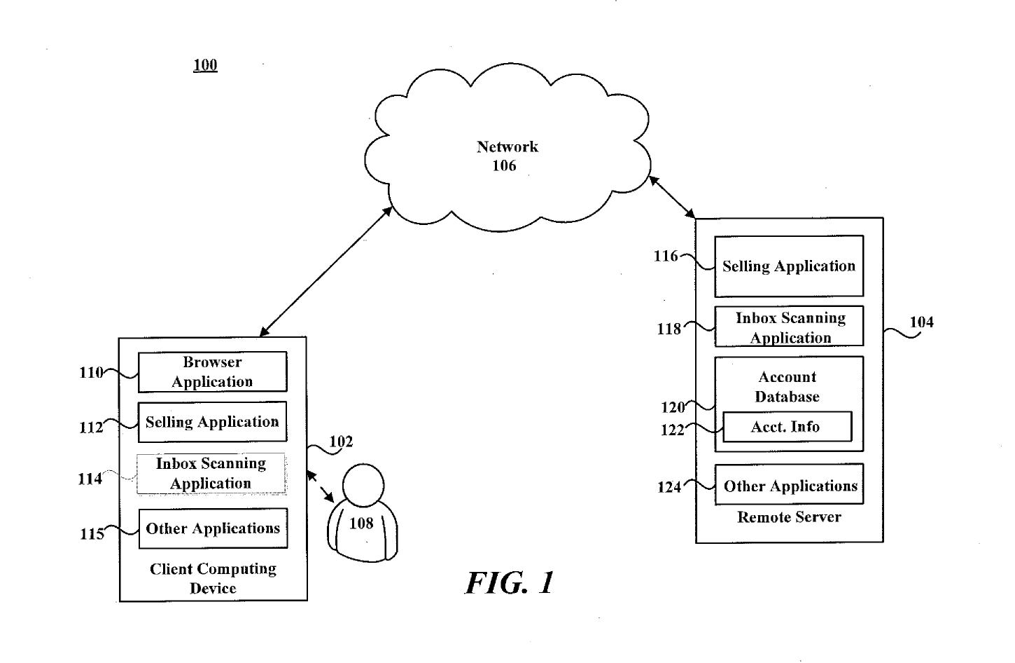

FIG. 1 is a block diagram of a networked system 100, consistent with some embodiments. System 100 includes a client computing device 102 and a remote server 104 in communication over a network 106. Remote server 104 may be a hosting server that hosts webpages and other online content accessible by user 108 using client computing device 102 over network 106. In some embodiments, remote server 104 may correspond to an online marketplace server where users such as user 108 can buy and sell goods and items (collectively referred to as “items”), such as may be provided by eBay Inc. of San Jose, Calif. Remote server 104 may be maintained by other service providers in different embodiments. In some embodiments, remote server 104 may correspond to a payment service processing server and also host merchant-specific content. Moreover, remote server 104 may correspond to one or more servers in some embodiments.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

Client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. In some embodiments, the instructions may be executed by the one or more processors in response to interaction by a user 108. For example, such instructions may include a browser application 110 such as a mobile browser application, which may be used to provide a user interface to permit user 108 to browse information available over network 106, including information hosted by remote server 104. For example, browser application 110 may be implemented as a web browser to view information available over network 106. Browser application 110 may include a graphical user interface (GUI) that is configured to allow user 108 to interface and communicate with remote server 104 or other servers managed by content providers or merchants via network 106. For example, user 108 may be able to access websites to find and purchase items, as well as access user account information or web content.

Client computing device 102 may also include a selling application 112. In some embodiments, selling application 112 may provide functionalities to allow user 108 to sell one or more items on an online marketplace such as may be provided by remote server 104. The functionalities provided by selling application 112 may include allowing user 108 to list one or more items for sale, including providing item information, product descriptions and the like. In some embodiments, the functionality provided by selling application 112 may also be provided by browser application 110. In some embodiments, selling application 112 (or similar functionality provided by browser application 110) may provide a convenient selling experience to user 108 by automatically completing or filling in information required for listing an item for sale.

Client computing device 102 may include an inbox scanning application 114. In some embodiments, user 108 may opt-in to allowing messages in their inbox to be scanned for product and item information. In some embodiments, inbox scanning application 112 may scan messages in one or more inboxes of user 108, including personal e-mail inboxes, inboxes provided and hosted by remote server 106, and received short messaging service (SMS) inboxes, for product and item information. In particular, inbox scanning application 112 may scan messages for receipts, purchase notifications, shipping notifications, and the like to determine product information associated with products that user 108 purchases. The product information may include product names, descriptions, bar codes, Universal Product Codes (UPC), Quick Response (QR) codes, stock-keeping unit (SKU) numbers, and other information that may describe products that user 108 purchases. In some embodiments, the product information may also include item information that may be used to describe the item or product if user 108 decides to later sell the product or item, including providing autofill capabilities to selling application 112 (or similar functionality provided by browser application 110). In some embodiments, the product information may also be used to search for item information. For example, the UPC of a purchased product may be used to search for item information over network using one or more search providers or through remote server 106. In general, product information may refer to information that identifies the product or item, and item information may refer to information and details associated with the product or item.

Client computing device 102 may further include other applications 115 as may be desired in one or more embodiments to provide additional features available to user 108, including accessing a user account with remote server 104. For example, applications 115 may include interfaces and communication protocols that allow the user to receive and transmit information through network 106 and to remote server 104 and other online sites. Applications 115 may also include security applications for implementing client-side security features, programmatic client applications for interfacing with appropriate APIs over network 106 or various other types of generally known programs and/or applications.

Remote server 104 may include any appropriate combination of hardware and/or software having one or more processors and capable of reading instructions stored on a tangible non-transitory machine-readable medium for execution by the one or more processors. Consistent with some embodiments, remote server 104 includes a machine-readable medium, such as a memory (not shown) that includes instructions for execution by one or more processors (not shown) for causing remote server 106 to perform specific tasks. Remote server 104 may be maintained by an online marketplace server where users such as user 108 can buy and sell items, such as may be provided by eBay Inc. of San Jose, Calif. Remote server 104 may include a selling application 116 which may be capable of interfacing with selling application 112 and/or browser 110 of client computing device 102. In some embodiments, selling application 116 may receive information provided by user 108 in selling application 112 (or browser application 110) and use the information to create a sale listing for one or more items that user 108 is selling. In some embodiments, remote server 104 may be capable of autofilling item information to create the sale listing using product information obtained by scanning an inbox of user 108.

Remote server 104 may also include may include an inbox scanning application 118. In some embodiments, user 108 may opt-in to allowing messages in their inbox to be scanned for product and item information. In some embodiments, inbox scanning application 118 may scan messages in one or more inboxes of user 108, including personal e-mail inboxes and inboxes provided by remote server 104 for user 108, for product and item information. In particular, inbox scanning application 118 may scan messages for receipts, purchase notifications, shipping notifications, and the like to determine product information associated with products that user 108 purchases. Remote server 104 may further include an account database 120 that includes account information 122 for users having an account on remote server 104, such as user 108. Remote server 104 may include other applications 124 providing other functionalities.

Although discussion has been made of applications and applications on client computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications. Moreover, although both remote server 106 and client computing device 102 have been described has having an inbox scanning application 118 and 114, respectively, in some embodiments one of remote server 106 and client computing device 102 may have an inbox scanning application 118 or 114 installed thereon and be capable of scanning an inbox associated with user 108 to provide functionalities consistent with embodiments described herein.

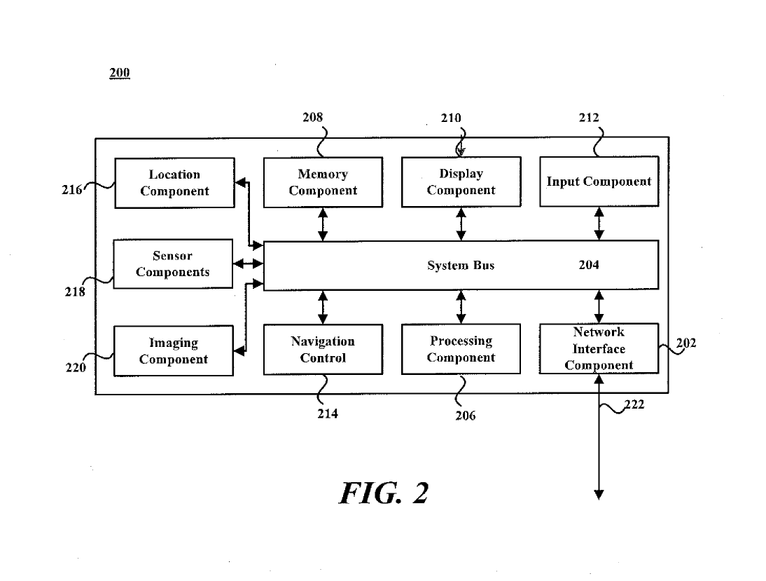

FIG. 2 is a diagram illustrating computing system 200, which may correspond to either of client computing device 102 or remote server 104, consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with remote server 104. As shown in FIG. 2, computing system 200 includes a network interface component (NIC) 202 configured for communication with a network such as network 106 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 108 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as user 108, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if device 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into client computing device 102 or sensor peripherals coupled to client computing device 102. Sensor components 218 may include any sensory device that captures information related to user 108 and/or client computing device 102 that may be associated with any actions that user 108 performs using client computing device 102. Sensor components 218 may include accelerometers, biometric readers, GPS devices, and other devices that are capable of providing information about client computing device 102 or user 108, or an environment therearound. Computing system 200 may also include an imaging component 220. In some embodiments, imaging component 220 may be an optical camera capable of capturing images. In some embodiments, the captured images may be a series of captured images, such as video frames.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 106 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

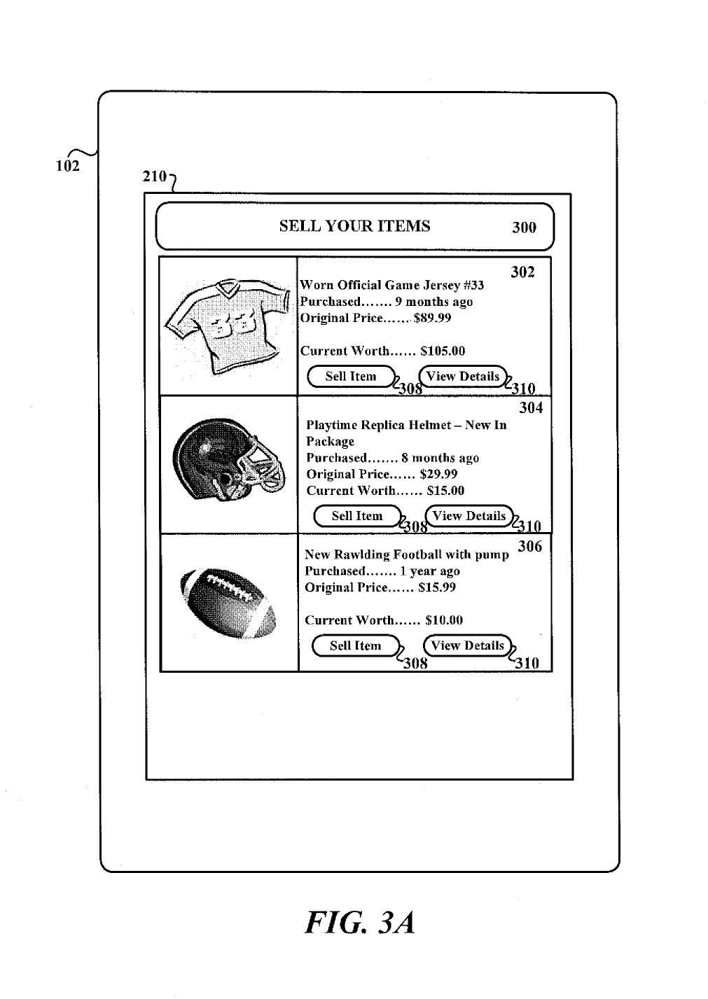

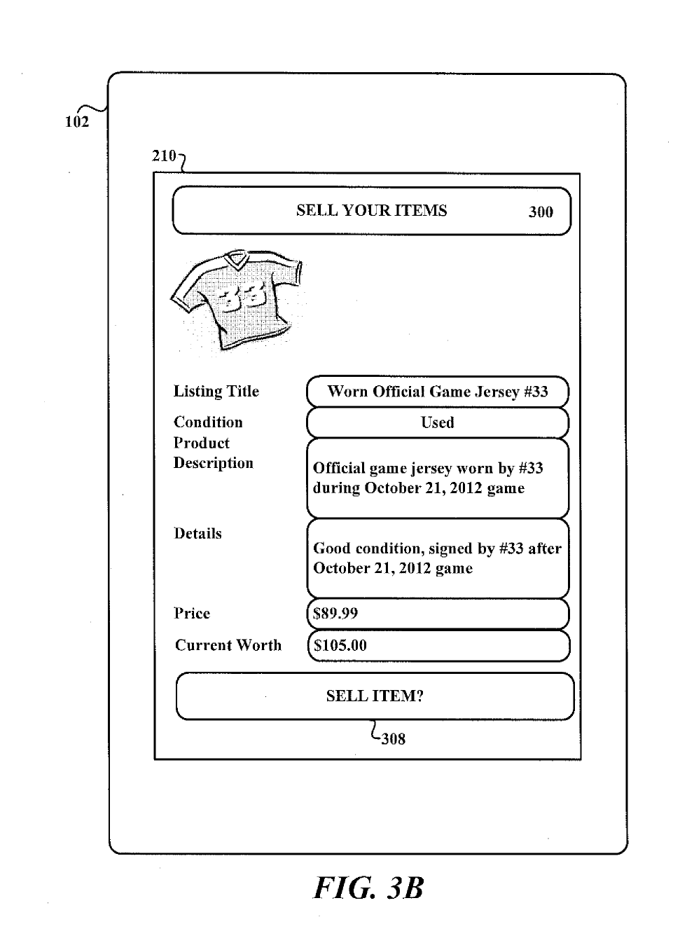

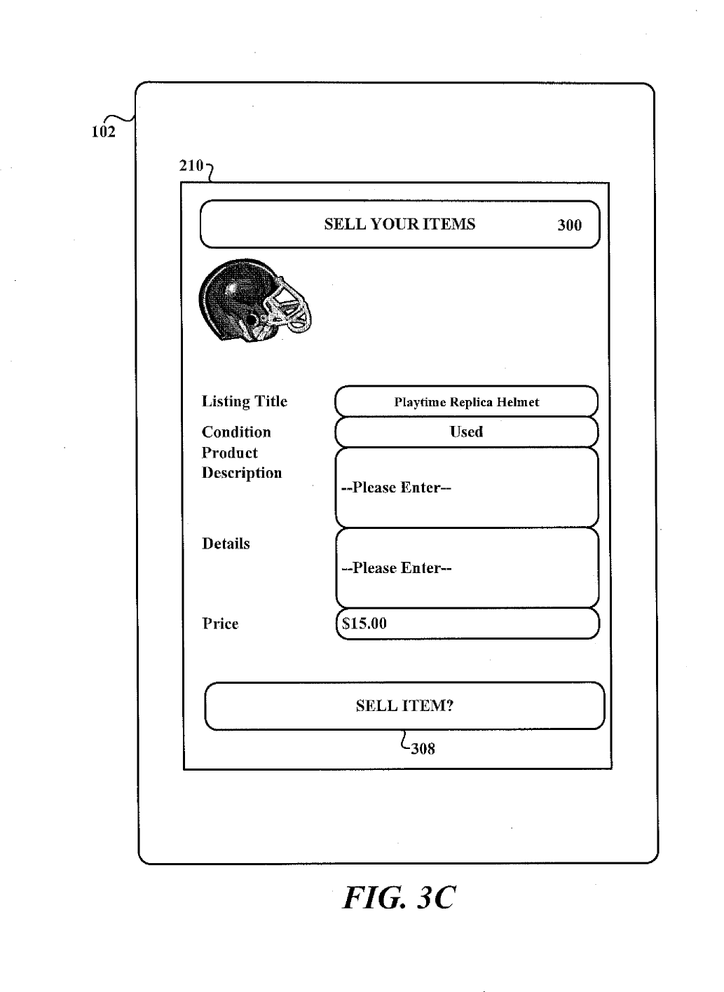

FIGS. 3A-3C illustrate an example an example interface 300 for selling items with minimal user input, consistent with some embodiments. In some embodiments, interface 300 may be provided by selling application 112 or 116 and may include entries 302, 304, and 306 of items that user 108 may want to sell. Moreover, entries 302, 304, and 306 may include product information that may include item information obtained by inbox scanning application 114 or 118, or may be product information including item information provided to remote server 104. In some embodiments, entries 302, 304, and 306 may include product information including item information stored by remote server 104 based on past purchases made through or facilitated by remote server 104.

As shown in FIG. 3A, entries 302, 304, and 306 in interface 300 may include product information such as a title or listing entry, as well as item information including when it was purchased by user 108, how much user 108 paid for the item, and an estimated current worth. In some embodiments, the estimated current worth may be determined by processing component 206 of remote server 104 based on information obtained through other sales made or facilitated by remote server 104 or information obtained from third parties. Entries 302, 304, and 306 in interface 300 may also include selectable areas, or buttons, that may be selected by user 108 for selling the item 308 or viewing details about the item 310. In some embodiments, if user 108 selects the button for selling the item 308, selling application 112 or 116 may use stored product and item information and/or product and item information obtained by inbox scanning application 114 or 118 to complete a selling description. Moreover, in some embodiments, if user 108 selects the button for viewing details about the item 310, selling application 112 or 116 may use stored product and item information and/or product and item information obtained by inbox scanning application 114 or 118 to provide details about the item for viewing.

As shown in FIG. 3B, when user 108 selects the button for selling an item 308, interface 300 may display the product and item information for user 108 to review. The displayed information may include product information such as a listing title, and additional item information such as a condition of the item, a brief product description, additional details about the item, a price of the item as well as a current worth of the item. In some embodiments, the product and item information shown in interface 300 may be obtained by inbox scanning application 114 or 118 when user 108 selects the button for viewing details of the item. In other embodiments, the product and item information shown in interface 300 may be obtained by inbox scanning application 114 or 118 when a message including such details is received in an inbox associated with user 108 and stored for later retrieval in memory component 208 of user device 102 and/or remote server 104. In some embodiments, the product and item information may be stored in account information 122 in account database. As an example, when user 108 purchased the item, user 108 may have received a message in an inbox that included the product and item information shown in interface 300. Inbox scanning application 114 or 118 may then parse this information and store the information, or may parse this information when user 108 wants to sell the item. Further, the product and item information shown in interface 300 in FIG. 3B may be the same product and item information that will be displayed when user 108 selects the button to view details of an item 310.

As shown in FIG. 3C, when user selects the button for selling an item 308, selling application may attempt to autofill a selling description using information parsed by inbox scanning application 114 or 118, but may not be able to obtain all of the item information required to complete the selling description. For example, if user 108 has deleted a message including the item information from an inbox, or if a message in an inbox of user 108 does not include sufficient item information to autofill a selling description, selling application 112 or 116 may attempt to search over network 106 for the additional information, or may require user 108 to enter the required information as shown in FIG. 3C. User 108 may then be able to manually enter item information into interface 300 and, when complete, may press the button for selling items 308 to place a listing for the item using the entered information.

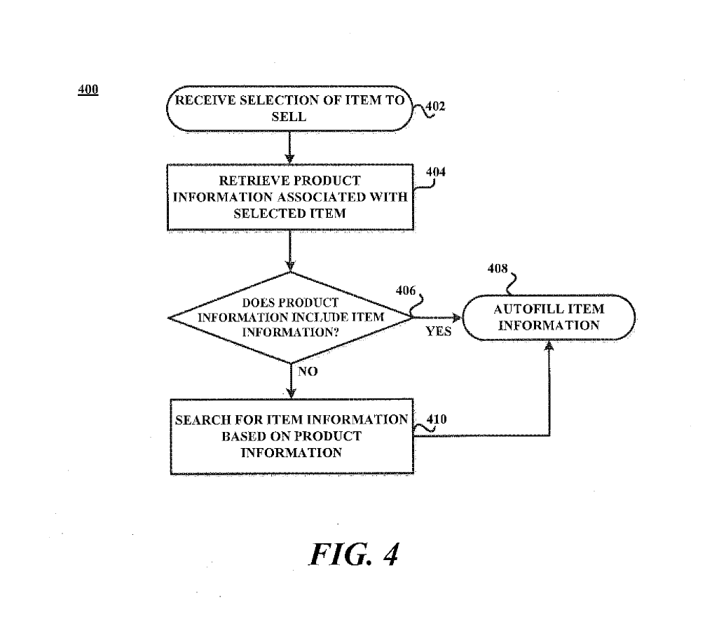

FIG. 4 is a flowchart illustrating a process 400 for autofilling item information for selling, consistent with some embodiments. For the purpose of illustration, FIG. 4 may be described with reference to any of FIG. 1, 2, or 3A-3C. Process 400 shown in FIG. 4 may be embodied in computer-readable instructions for execution by one or more processors such that the steps of process 400 may be performed by processing component 206 of client computing device 102 or remote server 104. In some embodiments, selling application 112 of client computing device 102 and selling application 116 of remote server 104 may include instructions for performing one or more steps of process 400. As shown in FIG. 4, process 400 may be initiated when a selection of an item to sell (402). In some embodiments, user 108 may be presented with a display or interface illustrating items that user 108 has previously purchased, for example, through an online marketplace hosted by remote server 104. In some embodiments, user 108 may execute selling application 112 on client computing device 102 or, using browser application 110, and may be presented with an interface for entering or selecting an item for selling and entering item information sufficient to describe the item to would-be buyers, such as interface 300.

After the item to be sold has been selected and/or entered by user 108, product information associated with the item may be retrieved (404). In some embodiments, inbox scanning application 114 or 118 scans or has scanned messages in inboxes associated with user 108 for item and product information. The product information may include product names, descriptions, bar codes, Universal Product Codes (UPC), Quick Response (QR) codes, stock-keeping unit (SKU) numbers, and other information that may describe products that user 108 purchases. In some embodiments, the product information may also include item information that may be used to describe the item. User 108 may have an opportunity to review the autofilled information. If the retrieved product information includes the requisite item information (406) for completing a selling description, the item information may be autofilled (408). If the retrieved product information does not include the necessary item information for completing a selling description, the item information may be searched for based on the product information (410) which, when found, may be used to autofill item information (408). In some embodiments, the product information retrieved from scanning inboxes may include product numbers, product names, product descriptions, SKU's, and the like, which may be used to search for item information. In some embodiments, the product information may be used to search over network 106 on third party servers, or within remote server 104. Consequently, process 400 may allow user 108 having opted-in to inbox scanning to sell items by selecting or entering an item for sale. In some embodiments, user 108 may be able to enter additional information about the item if the product information does not have the requisite information for completing a selling description.

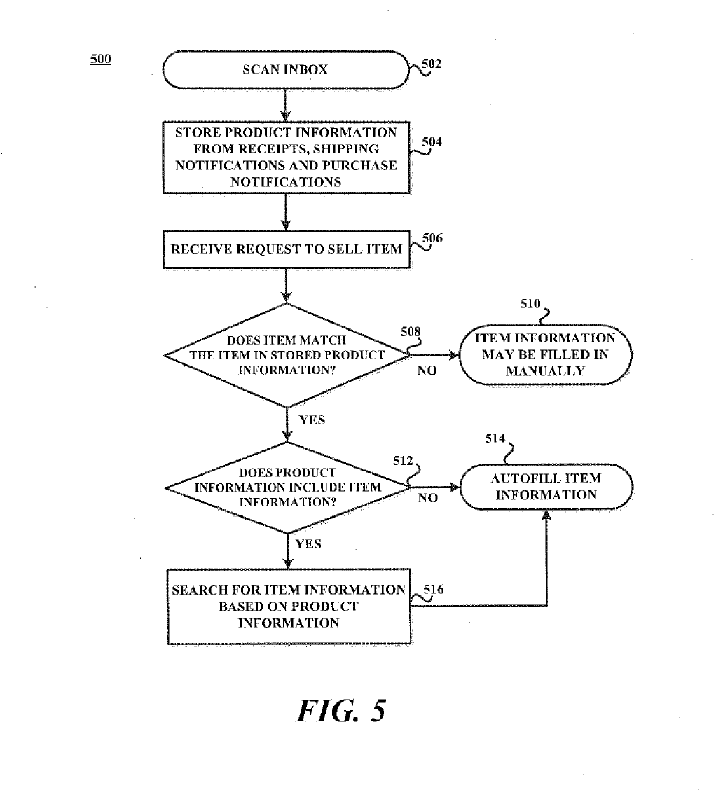

FIG. 5 is a flowchart illustrating a process 500 for scanning inboxes and autofilling item information for selling, consistent with some embodiments. For the purpose of illustration, FIG. 5 may be described with reference to any of FIG. 1, 2 or 3A-3C. Process 500 shown in FIG. 5 may be embodied in computer-readable instructions for execution by one or more processors such that the steps of process 500 may be performed by processing component 206 of client computing device 102 or remote server 104. In some embodiments, selling application 112 and inbox scanning application 114 of client computing device 102 and selling application 116 and inbox scanning application 118 of remote server 104 may include instructions for performing one or more steps of process 500. As shown in FIG. 5, process 500 includes scanning an inbox associated with user 108 (502) and storing product information from receipts, shipping, notifications, purchase notifications, and the like (504). In some embodiments, user 108 may opt-in to allowing messages in their inbox to be scanned for product and item information. In some embodiments, inbox scanning application 114 or 118 may scan messages in one or more inboxes associated with user 108, including personal e-mail inboxes, SMS inboxes, and inboxes provided by remote server 104 for user 108, for product and item information.

When a request to sell an item by user 108 is received (506) selling application 112 or 116 may determine if the item that user 108 wants to sell matches an item stored in the product information from scanning inboxes associated with user 108 (508). In some embodiments, when user 108 requests to sell an item, user 108 may be presented with an interface, such as interface 300, for entering product and/or item information that may be used to describe the item for sale and provide sufficient information to would-be buyers to make an informed decision as to whether or not they should buy the item. If the item that user 108 is requesting to sell does not match an item that was stored in product information from scanning inboxes, user 108 may have to fill in the item information manually into a selling description (510). If the retrieved product information includes the requisite item information (512) for completing a selling description, the item information may be autofilled (514). User 108 may have an opportunity to review the autofilled information. If the retrieved product information does not include the necessary item information for completing a selling description, the item information may be searched for based on the product information (516) which, when found, may be used to autofill item information (514). In some embodiments, the product information retrieved from scanning inboxes may include product numbers, SKU's, and the like, which may be used to search for item information. In some embodiments, the product information may be used to search over network 106 on third party servers, or within remote server 104.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments consistent with this disclosure may scan a seller's inbox for messages related to the items to determine information about the item that can be used to autofill the item information for selling. In particular, systems and methods described herein may allow a user to quickly sell an item with a minimum of user input. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system, comprising:
a network interface component configured to receive messages over a network including product information for items purchased by a user, the product information including item information;
a memory configured to store the product information and item information; and
one or more processors configured to automatically enter the item information into a selling description before the user lists one or more of the purchased items for sale.

2. The system of claim 1, wherein the memory is further configured to store the received messages in an inbox associated with the user.

3. The system of claim 2, wherein the one or more processors are further configured to scan the inbox for the item information when the user sells one or more of the purchased items.

4. The system of claim 1, wherein the one or more processors automatically entering the product information and item information into a selling description comprises automatically entering the item information associated with a selected item into a selling description when the user selects the item to list for sale.

5. The system of claim 1, wherein the one or more processors are further configured to request manual entry of item information when the stored product information does not include item information is sufficient to complete the selling description.

6. The system of claim 1, wherein the one or more processors automatically entering the product and item information into a selling description comprises searching for item information using the stored product information when the item information is insufficient to complete the selling description.

7. The system of claim 1, wherein the one or more processors searching for item information using the product information comprises searching in at least one of the memory and the network.

8. The system of claim 1, wherein the system comprises at least one of a user device and one or more servers hosting an online marketplace.

9. The system of claim 1, wherein the product information comprises at least one of a product name, product description, a bar code, a Universal Product Code (UPC), a Quick Response (QR) code, and a stock-keeping unit (SKU) number.

10. A computer-readable medium including instructions that, when executed by one or more processors, cause the one or more processors to perform a method for automatically entering item information for an item being sold, the method comprising:
retrieving product information associated with the item in response to receiving a selection of the item as an item to sell, the product information including information stored from scanning one or more inboxes;
automatically entering the item information when the product information includes the item information; and
searching for the item information based on the product information when the product information does not include the item information.

11. The computer-readable medium of claim 10, further comprising:
scanning the one or more inboxes for the product information; and
storing the product information from the scanning.

12. The computer-readable medium of claim 11, wherein the product information comprises at least one of a product name, product description, a bar code, a Universal Product Code (UPC), a Quick Response (QR) code, and a stock-keeping unit (SKU) number.

13. The computer-readable medium of claim 10, wherein the item information comprises item details used to create a listing for selling the item on an online marketplace.

14. The computer-readable medium of claim 10, further comprising receiving a manual entry of the item information when the product information does not include sufficient item information.

15. The computer-readable medium of claim 10, wherein searching for the item information based on the product information comprises searching over a network and within one or more databases of an online marketplace.

16. A computer-readable medium including instructions that, when executed by one or more processors, cause the one or more processors to perform a method for automatically entering item information for an item being sold, the method comprising:
scanning one or more inboxes associated with a user;
storing product information from messages in the one or more inboxes, the product information including item information;
determining if the item matches an stored product information when a request to sell the item is received;
automatically entering the item information for the item when the item matches stored product information and the product information includes the item information; and
searching for the item information based on the product information when the item matches stored product information and the product information does not include the item information.

17. The computer-readable medium of claim 16, wherein the method further comprises:
requesting that the item information be entered manually when the item does not match stored product information.

18. The computer-readable medium of claim 16, wherein the method further comprises:
requesting that the item information be entered manually when searching for the item information does not find the item information.

19. The computer-readable medium of claim 16, wherein the product information comprises at least one of a product name, product description, a bar code, a Universal Product Code (UPC), a Quick Response (QR) code, and a stock-keeping unit (SKU) number.

20. The computer-readable medium of claim 16, wherein the item information comprises item details used to create a listing for selling the item on an online marketplace.
